(19) United States
(12) Patent Application Publication
(10) Pub. No.: US 2006/0230080 A1
(43) Pub. Date: Oct. 12, 2006

(54) Apparatus for tracking work process and computer product

(75) Inventors: Hideki Okamoto, Kawasaki (JP); Toshiyuki Ito, Kawasaki (JP); Kazuo Mineno, Kawasaki (JP); Hirokazu Sato, Kawasaki (JP); Yasuomi Iriyama, Kawasaki (JP); Yasushi Toriwaki, Kawasaki (JP)

Correspondence Address: Patrick G. Burns, Esq.;GREER, BURNS & CRAIN, LTD., Suite 2500, 300 South Wacker Drive, Chicago, IL, 60606, US

(73) Assignee: FUJITSU LIMITED

(21) Appl. No.: 11/175,887

(22) Filed: Jul. 6, 2005

(30) Foreign Application Priority Data
Apr. 7, 2005 (JP) 2005-111198

(51) Int. Cl. G06F 17/30

(52) U.S. Cl. 707/203

(57) ABSTRACT

In an apparatus for tracking a work process, when a work model and its version to be updated are accepted, a registering unit updates a version-number management table based on the version accepted. When a work model to be tracked and a version number of the work model to be tracked are accepted, a specifying unit specifies information on operation time for the work model in a version of the version number. A tracking processing unit executes tracking of the work model in the version based on the information, and outputs a result of the tracking to a tracking terminal.

### CROSS-REFERENCE TO RELATED APPLICATIONS

This application is based upon and claims the benefit of priority from the prior Japanese Patent Application No.2005-111198, filed on Apr. 7, 2005, the entire contents of which are incorporated herein by reference.

### BACKGROUND OF THE INVENTION

1. Field of the Invention

The present invention relates to an apparatus for tracking a work process that indicates a workflow in various work systems, and a computer product.

2. Description of the Related Art

Due to a phase-in of work systems along with growth of a company or introduction of individual work system for each business unit, it is often the case that various work systems are present within a company. Because such various work systems have a complex relationship therebetween, it is difficult to grasp works as a whole. For example, such a problem can arise that it is difficult to understand progress of an entire work, problems in the work process, and what kind of an effect is expected when an investment in a new information technology (IT) is made for which part in a business.

For this reason, analysis of a work process that indicates a flow of work in the various work systems has conventionally been performed when works in operation are to be improved. Thus, it is determined which part has a problem and what should be improved. A workflow system is a system used for analyzing a flow of works in the work systems. The workflow system in general includes an existing flow engine and an application to be automatically executed in the order according to a workflow presented.

A workflow supporting system and a workflow supporting method that enables to refer to managing information including history and progress and to track a flow even for a workflow that range various different work systems or non-routine works are disclosed in, for example, Japanese Patent Application Laid-Open Publication No. H10-63747.

However, in the conventional technology described above, it is impossible to grasp relation among applications that branches into various processes at some midpoints. In such case, to grasp the relation among the applications, the work process and an analyzing scheme have to be reviewed by, for example, dividing the workflow into processes to be analyzed separately.

In addition, most of the existing work systems do not process works according to a workflow. Therefore, to track a work flow in different work systems, it is necessary to collect data including processed data and unprocessed data by accessing each of the work systems to analyze the data. Such workflow tracking is practically impossible.

### SUMMARY OF THE INVENTION

It is an object of the present invention to at least solve the problems in the conventional technology.

A computer-readable recording medium according to one aspect of the present invention stores a computer program for tracking a work process that indicates a flow of work among a plurality of work systems. The computer program makes a computer execute accepting registration of a first updated version of a work model that is defined by the work systems, the first updated version being a version updated from a first version in which the work model is currently in operation; and registering, when the registration of the first updated version is accepted, information on time to end an operation of the work model in the first version and time to start an operation of the work model in the first updated version.

A computer-readable recording medium according to another aspect of the present invention stores a computer program for tracking a work process that indicates a flow of work among a plurality of work systems. The computer program makes a computer execute accepting registration of an updated version of a work model that is defined by the work systems, the updated version being a version updated from a current version in which the work model is not currently in operation; and registering, when the registration of the updated version is accepted, information on time to start and end an operation in the current version as information on time for the updated version.

An apparatus according to still another aspect of the present invention is for tracking a work process indicates a flow of a work among a plurality of work systems, and includes an accepting unit that accepts registration of a first updated version of a work model that is defined by the work systems, the first updated version being a version updated from a first version in which the work model is currently in operation; and a registering unit that registers, when the registration of the first updated version is accepted, information on time to end an operation of the work model in the first version and time to start an operation of the work model in the first updated version.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of a system for tracking a work process according to an embodiment of the present invention;

FIG. 2 is a schematic of a hardware configuration of an apparatus for tracking a work process according to the embodiment;

FIG. 3 is a schematic for illustrating a version change of a work model according to the embodiment;

FIGS. 4A to 4E are schematics for illustrating a work process of each version shown in FIG. 3;

FIG. 5 is a schematic of contents stored in a version-number management table according to the embodiment;

FIG. 6 is a block diagram of a functional configuration of the work process tracking apparatus;

FIG. 7 is a schematic of contents stored in an event database (DB);

FIG. 8 is a flowchart of an updating process for the version-number management table according to the embodiment; and

FIG. 9 is a flowchart of a work-process tracking process according to the embodiment.

### DETAILED DESCRIPTION OF THE PREFERRED EMBODIMENTS

Exemplary embodiments according to the present invention will be described in detail below with reference to the accompanying drawings. Among various work systems, relation between works and a flow of the works are always changing according to review of a business process. According to the present embodiment, it is possible not only to accumulate and track the flow of the works among the various work systems, but also to determine a tracking range by comparing changes in the relation and information accumulated.

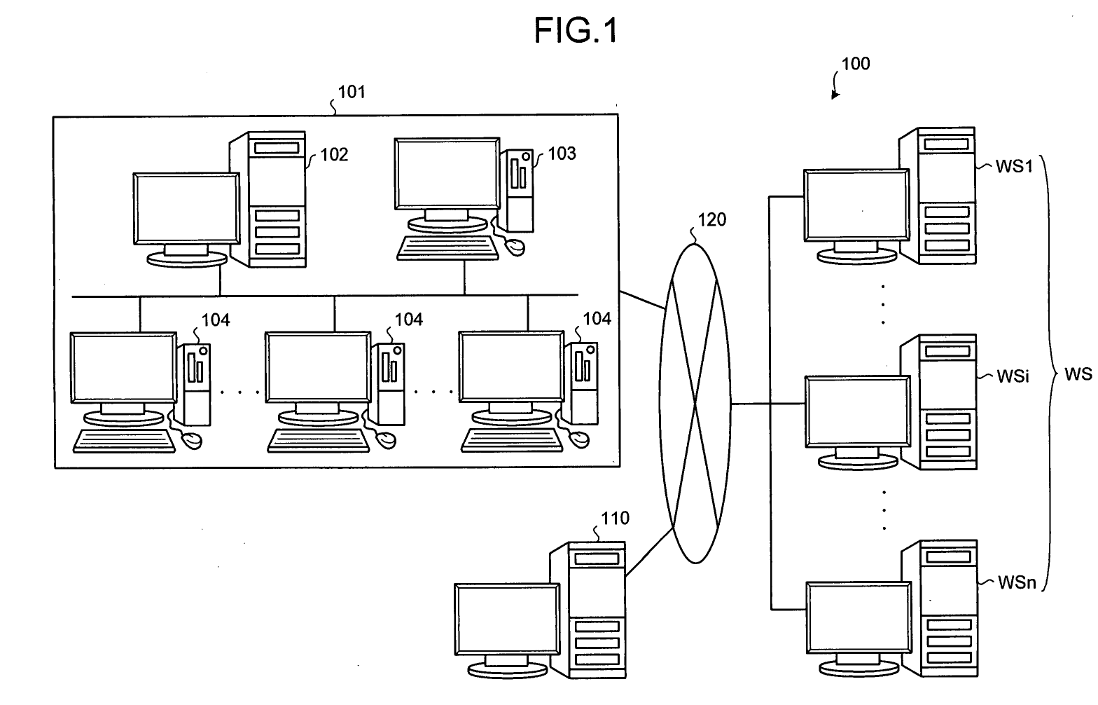

FIG. 1 is a schematic of a system for tracking a work process according to an embodiment of the present invention.

As shown in FIG. 1, a work process tracking system 100 includes an internal system 101, a work system group WS, and a backup server 110, which are inter-communicably connected to one another via a network 120, such as the Internet or a wide area network (WAN).

The internal system 101 includes a work process tracking apparatus 102, a managing terminal 103, and tracking terminals 104, which are inter-communicably connected to one another to form an internal network, such as a local-area network (LAN). The work process tracking apparatus 102 performs tracking, monitoring, and management of the work process. The managing terminal 103 sets a schedule of processes regarding instructions for a start or a termination operation, tracking, monitoring, and management of the work process tracking apparatus 102. The tracking terminals 104 each access the work process tracking apparatus 102 to make a request for tracking a target work process, specify a tracking target, and display the tracking results.

The work system group WS is a set of a plurality of different work systems WS1 to WSn defined according to a work model. Each work system WSi is not aware of the state of operation of another work system WSj (j‥i). The number n of work systems WS1 to WSn in the work system group WS is assumed to be four for simplifying description. For example, if the work model handles from orders to manufacturing and marketing of products, the work system group WS is formed of four work systems, that is, an order-accepting and order-placing system (work system WS1), an inventory management system (work system WS2), a production system (work system WS3), and a shipping system (work system WS4). The work process indicates a work flow among the work systems WS1 to WSn. Therefore, the work process in this case is a series of processes from an order-accepting and order-placing process, an inventory managing process, a producing process, and then a shipping process. The number n of work systems WS1 to WSn in the work system group WS is assumed to be four for simplifying description. For example, if the work model handles from accepting orders to shipping products, the work system group WS is formed of four work systems, that is, an order-accepting system (work system WS1), a procurement system (work system WS2), an assembling system (work system WS3), and a shipping system (work system WS4). The work process indicates a task flow among the work systems WS1 to WSn. Therefore, the work process in this case is, for example, a series of processes from a process of accepting an order for a product to a procurement and management process, an assembling process, and a shipping process.

In practice, the number n of work systems WS1 to WSn can be several tens to hundreds or more. As such, the work process to be tracked has been expanded in size and diversified. In the present embodiment, such expanded and diversified work process can be efficiently tracked, monitored, and managed. Also, the backup server 110 backs up information stored in the work process tracking apparatus 102.

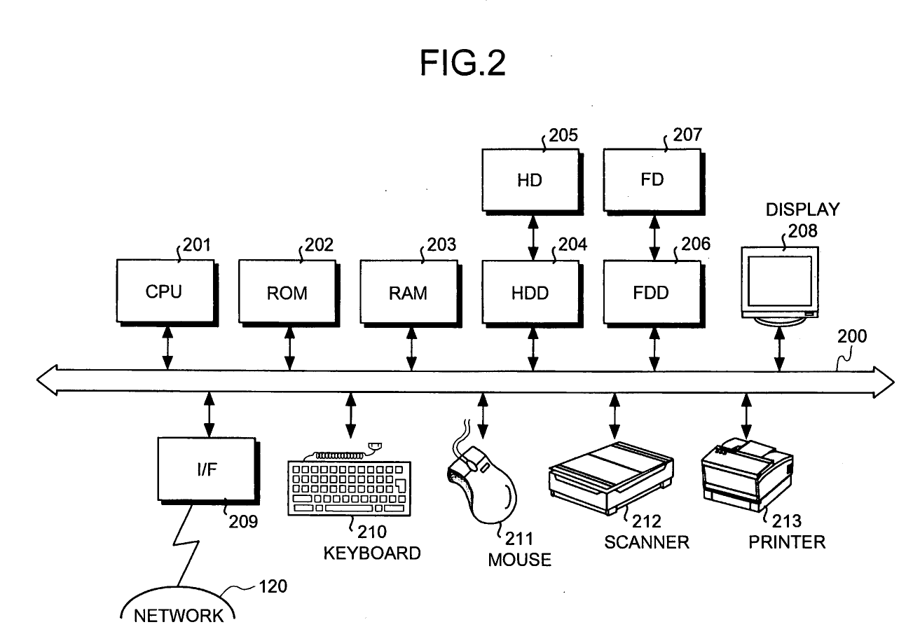

FIG. 2 is a schematic of a hardware configuration of the work process tracking apparatus 102, the managing terminal 103, the tracking terminals 104, the backup server 110, and the work systems WS1 to WSn (these components are collectively referred to as “the work process tracking apparatus 102 and their components”) according to the embodiment.

As shown in FIG. 2, the work process tracking apparatus 102 and other components include a central processing unit (CPU) 201, a read-only memory (ROM) 202, a random-access memory (RAM) 203, a hard disk drive (HDD) 204, a hard disk (HD) 205, a flexible disk drive (FDD) 206, a flexible disk (FD) 207, which is one example of a removable recording medium, a display 208, an interface (I/F) 209, a keyboard 210, a mouse 211, a scanner 212, and a printer 213. The components are connected to one another via a bus 200.

The CPU 201 controls the entire work process tracking apparatus 102 and other components. On the ROM 202, a program, such as a boot program, is recorded. The RAM 203 is used as a work area for the CPU 201. The HDD 204 controls read/write of data from/to the HD 205 under the control of the CPU 201. In the HD 205, data written under the control of the HDD 204 is stored.

The FDD 206 controls read/write of data from/to the FD 207 under the control of the CPU 201. The FD 207 causes data written under the control of the FDD 206 to be stored or causes the data stored in the FD 207 to be read by the work process tracking apparatus 102 and other components.

As a removable recording medium, besides the FD 207, a compact disc read-only memory (CD-ROM), such as compact disc-recordable (CD-R) and compact disc rewritable (CD-RW), magneto-optical (MO) disk, digital versatile disk (DVD), and memory card, may be used. The display 208 displays data, such as documents, images, and functional information including a cursor, icon, or tool box. As the display 208, a cathode-ray tube (CRT), for example, thin-film transistor (TFT) liquid crystal display, or plasma display can be adopted.

The I/F 209 is connected to the network 120, such as the Internet, via a communication line, and is also connected via the network 120 to another apparatus. The I/F 209 serves as an interface between the network 120 and the inside of the device, and controls data inputs to and outputs from an external device. As the I/F 209, a modem or LAN adaptor can be adopted.

The keyboard 210 includes keys for inputting characters, numbers, various instructions, etc., for data inputs, and may be an input pad of a touch panel type or ten keys, for example. The mouse 211 is used to cause a cursor to be moved, an area to be selected, or a window to be moved or changed in size, for example. The mouse 211 may be arbitrary, such as a track ball or joystick, as long as it has a function as a pointing device.

The scanner 212 optically reads an image, and captures image data into the work process tracking apparatus 102 and other components. The scanner 212 may have an optical character recognition (OCR) function. Also, the printer 213 prints image data and document data. As the printer 213, a laser printer or ink jet printer may be adopted.

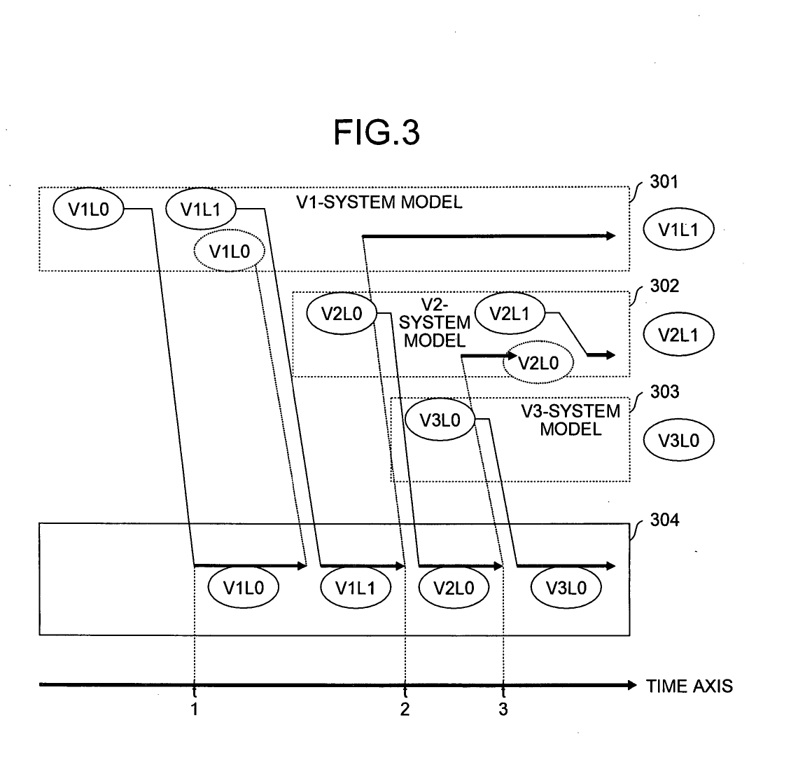

FIG. 3 is a schematic for illustrating a version change of a work model according to the embodiment. The number of types of versions of the work model managed in the present embodiment is defined as two.

One type is called a “major version”, which indicates a unit for identifying a definition file registered in the work model. Different major versions do not have an influence on each other. Of these major versions, a major version having the largest value is recognized as an active model of the work model. For example, a version-up of the major version is performed when a change has an influence on the flow of works (work process), such a change being exemplified by an addition, deletion, change, or replacement of a work system, or reshuffling of work systems.

The other type is called a “minor version”, which is a version identified in the major version described above. When a process is replaced in a work model of a major version, the value of the minor version is incremented and is then retained in a management table. Of the minor versions, a work model of a minor version having the largest value is used as a work model of the relevant major version. For example, a version-up of the minor version is performed when a change does not influence on the flow of works (work process), such a change includes a change in name of the work system in the work model or a change in property of the work system.

In the following, a version number of a work model is denoted as “VxLy” includes a major version and a minor version of that work model. “V” represents the major version, and “x” represents a value (version number) of the major version V. “L” represents the minor version, and “y” represents a value (version number) of the minor version L. For example, “V1L0” represents a work model having a major version 1 and a minor version 0.

As shown in FIG. 3, a definition file 301 represents a V1-system model having a version number of V1, a definition file 302 represents a V2-system model having a version number of V2, and a definition file 303 represents a V3-system model having a version number of V3. Work models in a frame 304 are active models. The active models are work models of the latest version defining the currently-operating work system group WS, the work models generating event data to be tracked by the tracking-terminal 104.

Also, as a work model, an order-accepting and shipping work model that handles from acceptance of orders for products to shipping is explained herein. In a version V1L0 at the beginning of introduction, the order-accepting and shipping work model includes the order-accepting system WS1, the procurement system WS2, the assembling system WS3, and the shipping system WS4.

First, when the order-accepting and shipping work model (version: V1L0) is an active model, upon occurrence of a change in name of any one of the systems WS1 to WS4, for example, a version-up of a minor version is performed, thereby updating the version number from “V1L0” to “V1L1”. Thus, the order-accepting and shipping work model (version: V1L1) becomes an active model.

Then, when a new work system is added, a version-up of a major version is performed. By registering the definition file 302 that represents the V2-system model, the version number is updated from “V1L1” to “V2L0”. Thus, the order-accepting and shipping work model (version: V2L0) becomes an active model.

The order-accepting and shipping work models (versions: V1L0 and V1L1), which are V1-system models, are active models during a period from t1 to t2, and become non-active models after t2. Under management, event data of the order-accepting and shipping work models (versions: V1L0 and V1L1) during the period from t1 to t2 is retained. Therefore, by specifying from the tracking terminal 104 a version number or a period, tracking of the event data can be performed.

Also, when the order-accepting and shipping work model (version: V2L0) is an active model and a new work system is added, a version-up of a major version is performed. By registering the definition file 303 that represents the V3-system model, the version number is updated from “V2L0” to “V3L0”. Thus, the order-accepting and shipping work model (version: V3L0) becomes an active model.

The order-accepting and shipping work model (version: V2L0), which is a V2-system model, is an active model during a period from t2 to t3, and becomes a non-active model after t3. Under management, event data of the order-accepting and shipping work model (versions: V2L0) during the period from t2 to t3 is retained. Therefore, by specifying from the tracking terminal a version number or a period, tracking of the event data can be performed.

Furthermore, when the order-accepting and shipping work model (version: V3L0) is an active model, a minor version-up of a non-active model, which is a previous version, can also be performed. For example, a work system in the order-accepting and shipping work model (version: V2L0) can be subjected to a minor version-up to produce the order-accepting and shipping work model (version: V2L1). Thus, under management, after this version-up, the order-accepting and shipping work model (version: V2L1) becomes a work model to be tracked of the V2-system model.

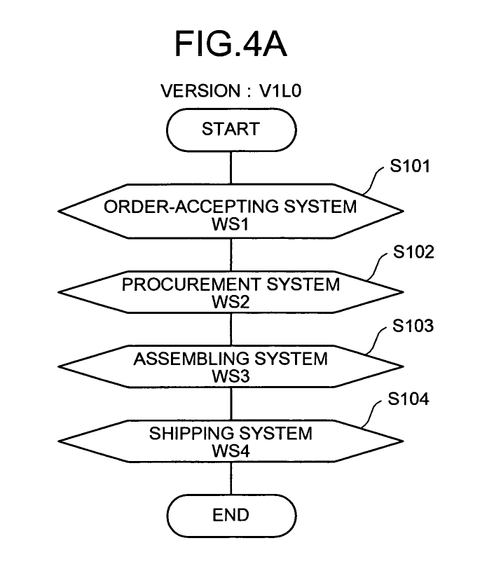

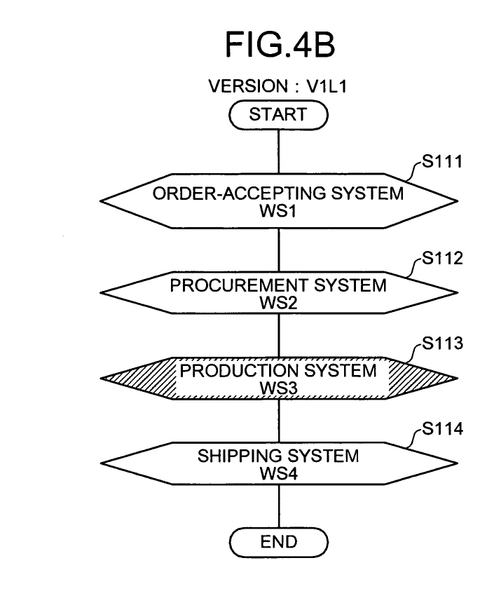

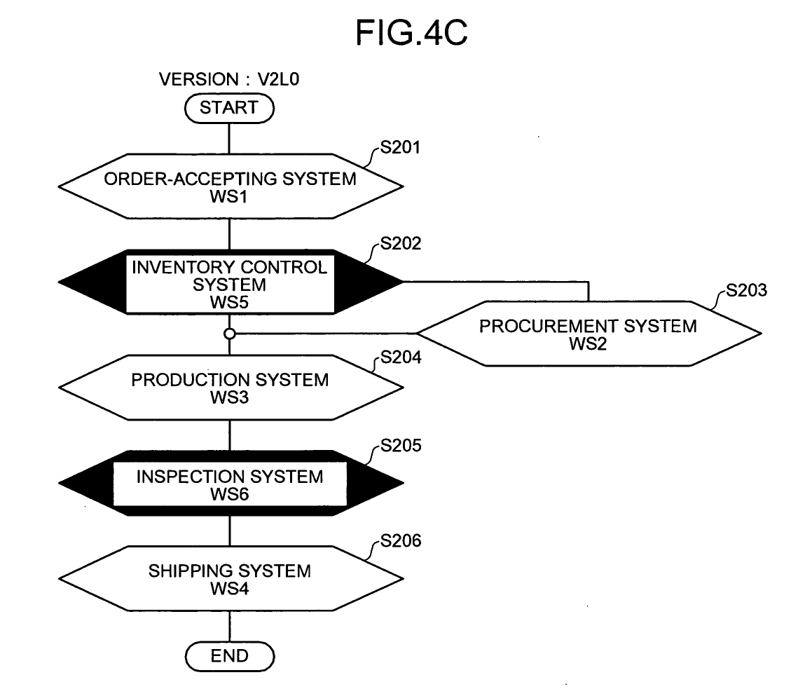

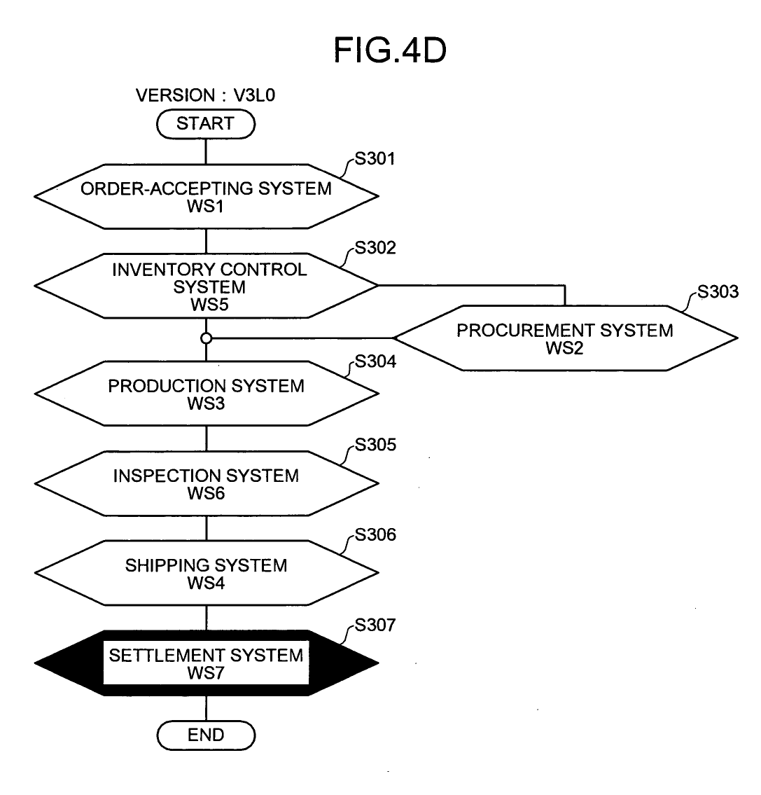

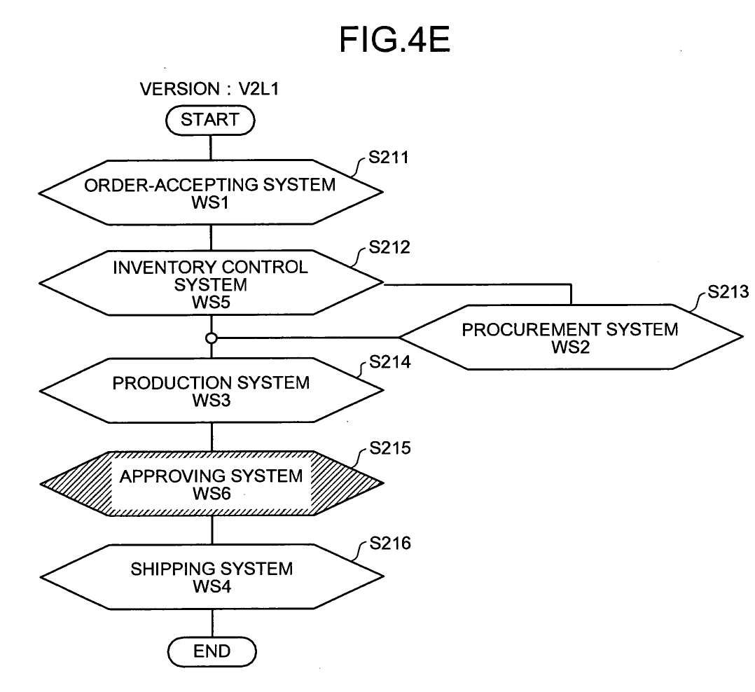

FIGS. 4A to 4E are schematics for illustrating a work process of each version shown in FIG. 3. FIG. 4A depicts a work process of the order-accepting and shipping work model (version: V1L0), and its work process is performed in the order of the order-accepting system WS1 (step S101), the procurement system WS2 (step S102), the assembling system WS3 (step S103), and then, the shipping system WS4 (step S104).

FIG. 4B depicts a work process of the order-accepting and shipping work model (version: V1L1). The order-accepting and shipping work model (version: V1L1) represents a result of a minor version-up (a name change from the assembling system WS3 shown at step S103 of FIG. 4A to a production system WS3) from the work process of the order-accepting and shipping work model (version: V1L0) shown in FIG. 4A, and its work process is performed in the order of the order-accepting system WS1 (step S111), the procurement system WS2 (step S112), the production system WS3 (step S113), and then the shipping system WS4 (step S114).

FIG. 4C depicts a work process of the order-accepting and shipping work model (version: V2L0). The order-accepting and shipping work model (version: V2L0) represents a result of a major version-up (addition of an inventory control system WS5 and an inspection system WS6) from the work process of the order-accepting and shipping work model (version: V1L1) shown in FIG. 4B, and its work process is performed in the order of the order-accepting system WS1 (step S201), the inventory control system WS5 (step S202), the procurement system WS2 (step S203), the production system WS3 (step S204), the inspection system WS6 (step S205), and then the shipping system WS4 (step S206). Note that the procurement system WS2 (step S203) is performed at the time of a shortage of inventory found at the inventory control system WS5 (step S202). If the inventory is sufficient, the production system WS3 (step S204) is performed.

FIG. 4D depicts a work process of the order-accepting and shipping work model (version: V3L0). The order-accepting and shipping work model (version: V3L0) represents a result of a major version-up (addition of a settlement system WS7) from the work process of the order-accepting and shipping work model (version: V2L0) shown in FIG. 4C, and its work process is performed in the order of the order-accepting system WS1 (step S301), the inventory control system WS5 (step S302), the procurement system WS2 (step S303), the production system WS3 (step S304), the inspection system WS6 (step S305), the shipping system WS4 (step S306), and then the settlement system WS7 (step S307). Note that the procurement system WS2 (step S303) is performed at the time of a shortage of inventory found at the inventory control system WS5 (step S302). If the inventory is sufficient, the production system WS3 (step S304) is performed.

FIG. 4E depicts a work process of the order-accepting and shipping work model (version: V2L1). The order-accepting and shipping work model (version: V2L1) represents a result of a minor version-up (a name change from the inspection system WS6 shown at step S205 of FIG. 4C to an approving system WS6) from the work process of the order-accepting and shipping work model (version: V2L0) shown in FIG. 4C, and its work process is performed in the order of the order-accepting system WS1 (step S211), the inventory control system WS5 (step S212), the procurement system WS2 (step S213), the production system WS3 (step S214), the approving system WS6 (step S215), and then the shipping system WS4 (step S216). Note that the procurement system WS2 (step S213) is performed at the time of a shortage of inventory found at the inventory control system WS5 (step S212). If the inventory is sufficient, the production system WS3 (step S214) is performed.

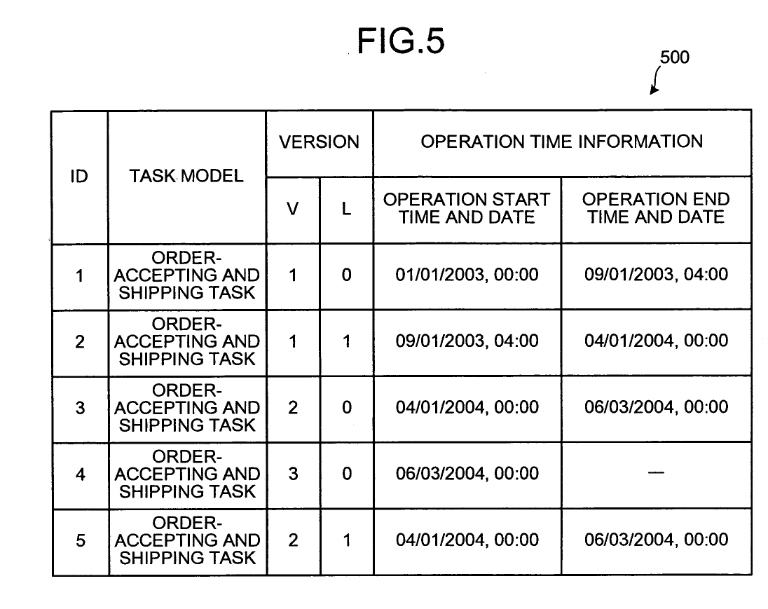

FIG. 5 is schematic of contents stored in a version-number management table-according to the embodiment. AS shown in FIG. 5, in a version-number management table 500, a version VxLy of each work model and operation time information are stored. The operation time information has an operation start time and an date, and an operation end time and date of the relevant version.

The operation start time and date matches with the operation end time and date of a version immediately before a version-up. In the case of the version number V1L0, the operation start time and date is a time and date when the work model is introduced. Also, when a minor version-up is performed without a non-active model, as for the version: V2L1, for example, a V3-system model with a major version-up has already become an active model. Therefore, the operation start and end times and dates are identical to those of the version number of V2L0.

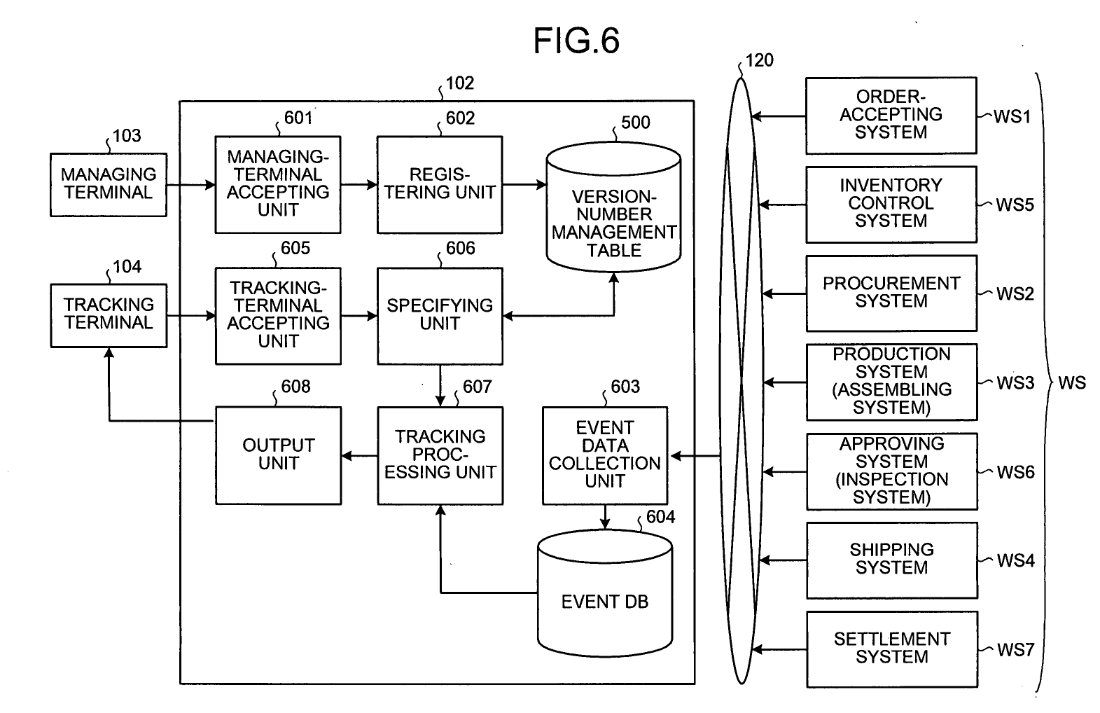

FIG. 6 is a block diagram of a functional configuration of the work process tracking apparatus 102. In FIG. 6, the work process tracking apparatus 102 includes the version-number management table 500, a managing-terminal accepting unit 601, a registering unit 602, an event-data collecting unit 603, an event DB 604, a tracking-terminal accepting unit 605, a specifying unit 606, a tracking processing unit 607, and an output unit 608.

First, the managing-terminal accepting unit 601 accepts information from the managing terminal 103. Specifically, a log-in from the managing terminal 103, a work model to be registered, and its version VxLy are accepted.

The registering unit 602 updates the version-number management table 500 according to the version information accepted by the managing-terminal accepting unit 601. Specifically, the work model name and the version information are registered in the version-number management table 500. Then, the operation time information is further registered. For example, when registration of version information based on a minor version-up from the version number of V1L0 is accepted, the version number of V1L1 is registered in a new ID of 2, and also the current time and date is registered in the operation start time and date. In this case, the current time and date is also registered in the operation end time and date of the immediately-preceding version with the version number V1L0.

The event-data collecting unit 603 collects event data from the work system group WS formed of work systems that are active models, according to a preset schedule. For example, when the order-accepting and shipping work model (version: V2L0) is an active model, as shown in FIG. 4C, the work process is performed in the order of the order-accepting system WS1 (step S201), the inventory control system WS5 (step S202), the procurement system WS2 (step S203), the production system WS3 (step S204), the inspection system WS6 (step S205), and then the shipping system WS4 (step S206).

Therefore, the event-data collecting unit 603 collects event data from the order-accepting system WS1, the inventory control system WS5, the procurement system WS2, the production system WS3, the inspection system WS6, and the shipping system WS4. The event-data collecting unit 603 then stores the collected event data in the event DB 604.

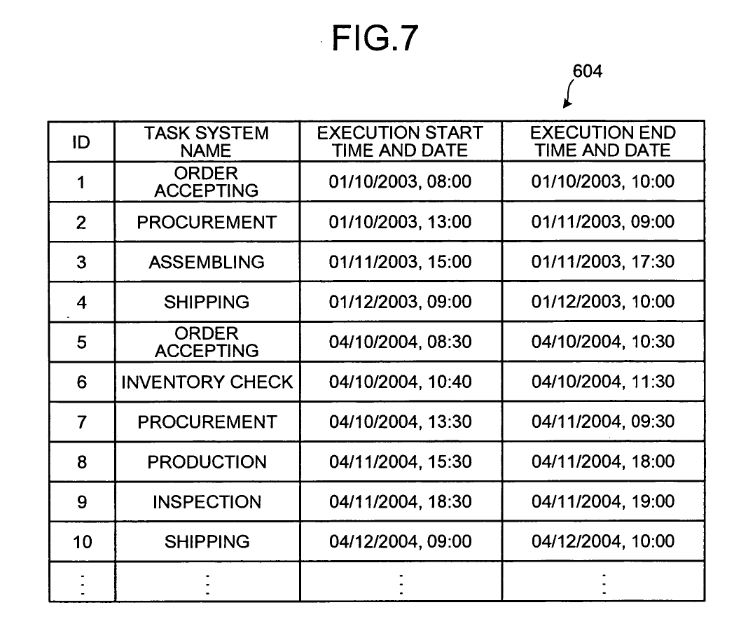

The event DB 604 stores the event data collected by the event-data collecting unit 603. FIG. 7 is a schematic of contents stored in the event DB 604. As shown in FIG. 7, the event DB 604 stores event data including a work system name, execution start time and date, and execution end time and date for each work system.

As shown in FIG. 6, the tracking-terminal accepting unit 605 accepts an instruction for a log-in, tracking, a work model to be tracked, and a version number from the tracking terminal 104. Based on the work model and its version number accepted by the tracking-terminal accepting unit 605, the specifying unit 606 refers to the version-number management table 500 to specify operation time information.

For example, when an instruction for tracking the order-accepting and shipping work model (version: V1L0) is accepted from the tracking terminal 104, an operation start time and date “00:00, Jan. 1, 2003,” and an operation end time and date “04:00, Sep. 1, 2003” of the order-accepting and shipping work model (version: V1L0) are specified in the version-number management table 500.

When an instruction for tracking the order-accepting and shipping work model (version: V3L0), which is an active model, is accepted, an operation start time and date “00:00, Jun. 3, 2004” of the order-accepting and shipping work model (version: V3L0) is specified in the version-number management table 500. Since the order-accepting and shipping work model (version: V3L0) is an active model, the operation end time and date is not specified, and a period from the operation start time and date to the current time and date is a period for tracking.

The tracking processing unit 607 retrieves event data stored in the event DB 604 according to the operation time information specified by the specifying unit 606, thereby tracking the work process. For example, when the specifying unit 606 specifies the operation start time and date “00:00, Jan. 1, 2003” and the operation end time and date “04:00, Sep. 1, 2003” of the order-accepting and shipping work model (version: V1L0), event data executed during a period from the operation start time and date to the operation end time and date, that is, event data from ID1 to ID4 in FIG. 7, is retrieved.

The output unit 608 outputs, as the tracking results, the event data retrieved by the tracking processing unit 607 to the tracking terminal 104 that requested for tracking. Specifically, the managing-terminal accepting unit 601, the registering unit 602, the event-data collecting unit 603, the tracking-terminal accepting unit 605, the specifying unit 606, the tracking processing unit 607, and the output unit 608 achieve their functions by, for example, the CPU 201 executing a program recorded on the ROM 202, the RAM 203, the HD 205, or the like, or by the I/F 209, shown in FIG. 2. Also, specifically, the version-number management table 500 and the event DB 604 achieve their functions by, for example, a recording medium such as the ROM 202, the RAM 203, and the HD 205 shown in FIG. 2.

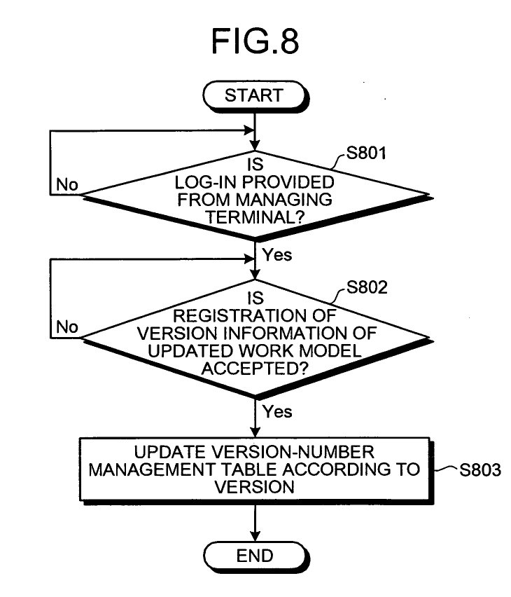

FIG. 8 is a flowchart of an updating process for the version-number management table 500 according to the embodiment. First, the managing-terminal accepting unit 601 waits for a log-in from the managing terminal 103 (“NO” at step S801), and when a log-in is provided (“YES” at step S801), the managing-terminal accepting unit 601 waits for registration of version information of an updated work model (“NO” at step S802). When registration of version information of an updated work model is accepted (“YES” at step S802), the registering unit 602 registers the accepted version information in the version-number management table 500, thereby updating the version-number management table 500 (step S803). Then, series of updating processes ends.

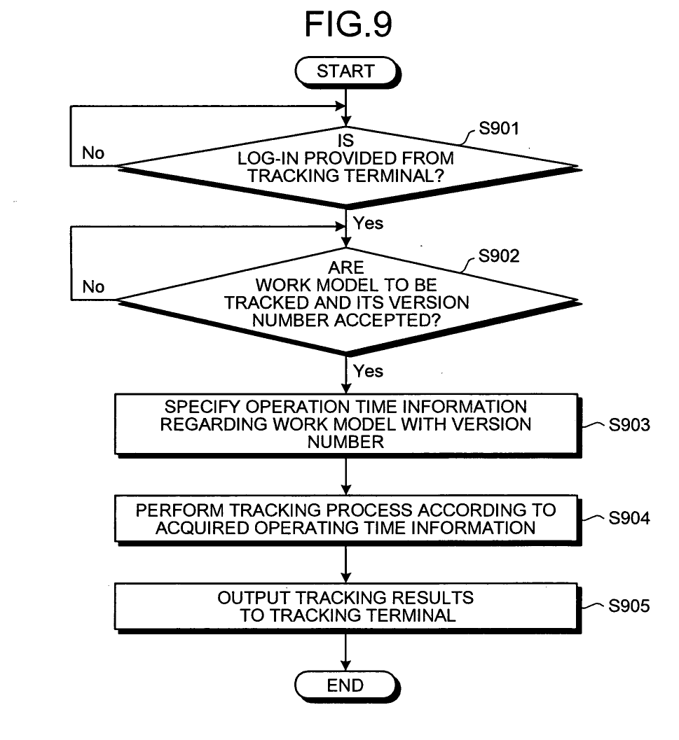

FIG. 9 is a flowchart of a work-process tracking process according to the embodiment. First, the tracking-terminal accepting unit 605 waits for a log-in from the tracking terminal 104 (“NO” at step S901), and when a log-in is provided (“YES” at step S901), the tracking-terminal accepting unit 605 accepts a work model to be tracked and its version number (“NO” at step S902).

When the work model to be tracked and its version number are accepted (“YES” at step S902), the specifying unit 606 specifies, in the version-number management table 500, operation time information regarding the work model with the accepted version number (step S903). The tracking processing unit 607 then executes a tracking process according to the obtained operation time information (step S904). The tracking results obtained through the tracking process are then output by the output unit 608 to the tracking terminal 104 (step S905). Then, a series of processes ends.

In a simple tracking system, individual work systems cannot ascertain the configuration of the entire business process. Therefore, in event data (start or end of a process) issued from a work system, information for recognition of the relation with another work system cannot be stored. Therefore, even if a change in business process leads to a change in the flow of the entire system, the change of the flow is not recognized in individual work systems. For this reason, information for distinction from an event issued at the time of a previous business process cannot be stored either.

Also, when version information is added to event data for distinction among different versions, each work system has to be reconstructed. At the same time, each work system has to be always aware of changes in a business process to which the work system belongs. Therefore, the existing system cannot be operated without changes.

On the other hand, according to the embodiment described above, even with a change in the work process, each work system does not have to be changed. Also, each work system does not have to be aware of the work process. Furthermore, event data of the latest work process and event data of a previous work process can be tracked in a distinguishable manner, thereby allowing an event analysis that accurately corresponds to the work model. Still further, a previous version can be subjected to a minor version-up without having an influence on the version of the currently-operating work model. Thus, an error in the work model of a previous version or cost information thereof can be corrected regardless of the current operation.

According to the present invention, easy and efficient operation and management of a work-process tracking system can be achieved.

The work-process tracking process described in the present embodiment can be achieved by a computer, such as a personal computer or a work station executing a computer program provided in advance. The computer program is recorded on a computer-readable recording medium, such as a hard disk, a flexible disk, a CD-ROM, an MO disk, or a DVD, and is executed by being read from the recording medium by a computer. Also, this program may be a transfer medium that can be distributed via a network, such as the Internet.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer-readable recording medium that stores a computer program for tracking a work process that indicates a flow of work among a plurality of work systems, the computer program makes a computer execute:
accepting registration of a first updated version of a work model that is defined by the work systems, the first updated version being a version updated from a first version in which the work model is currently in operation; and
registering, when the registration of the first updated version is accepted, information on time to end an operation of the work model in the first version and time to start an operation of the work model in the first updated version.

2. The computer-readable recording medium according to claim 1, wherein
the accepting includes accepting registration of a second updated version of the work model updated from a second version in which the work model is not currently in operation, and
the registering includes registering, when the registration of the second updated version is accepted, registering information on time to start and end an operation in the second version as information on time for the second updated version.

3. The computer-readable recording medium according to claim 1, wherein the computer program further makes the computer execute:
accepting a version to be tracked among versions of the work model;
specifying information on time for the version accepted from among the information registered; and
executing tracking of the work process based on the information specified.

4. A computer-readable recording medium that stores a computer program for tracking a work process that indicates a flow of work among a plurality of work systems, the computer program makes a computer execute:
accepting registration of an updated version of a work model that is defined by the work systems, the updated version being a version updated from a current version in which the work model is not currently in operation; and
registering, when the registration of the updated version is accepted, information on time to start and end an operation in the current version as information on time for the updated version.

5. The computer-readable recording medium according to 4, wherein the computer program further makes the computer execute:
accepting a version to be tracked among versions of the work model;
specifying information on time for the version accepted from among the information registered; and
executing tracking of the work process based on the information specified.

6. An apparatus for tracking a work process that indicates a flow of a work among a plurality of work systems, the apparatus comprising:
an accepting unit that accepts registration of a first updated version of a work model that is defined by the work systems, the first updated version being a version updated from a first version in which the work model is currently in operation; and
a registering unit that registers, when the registration of the first updated version is accepted, information on time to end an operation of the work model in the first version and time to start an operation of the work model in the first updated version.

7. The apparatus according to claim 6, wherein
the accepting unit accepts registration of a second updated version of the work model updated from a second version in which the work model is not currently in operation, and
the registering unit registers, when the registration of the second updated version is accepted, information on time to start and end an operation in the second version as information on time for the second updated version.

8. The apparatus according to claim 6, wherein the computer program further makes the computer execute:
a version-accepting unit that accepts a version to be tracked among versions of the work model;
a specifying unit that specifies information on time for the version accepted from among the information registered; and
an executing unit that executes tracking of the work process based on the information specified.
